(19) United States
(12) Patent Application Publication
(10) Pub. No.: US 2017/0253509 A1
(43) Pub. Date: Sep. 7, 2017

(54) METHOD AND SYSTEM FOR REMOVING PHOSPHORUS BY GASIFICATION

(71) Applicant: Jiangxi JDL Environmental Protection Co., Ltd., Nanchang (CN)

(72) Inventors: Zhimin LIAO, Nanchang (CN); Tao ZHOU, Nanchang (CN)

(21) Appl. No.: 15/602,054

(22) Filed: May 22, 2017

Related U.S. Application Data
(63) Continuation-in-part of application No. PCT/CN2015/091067, filed on Sep. 29, 2015.

(30) Foreign Application Priority Data
Sep. 1, 2015 (CN) 201510552171.X

(51) Int. Cl. C02F 3/12; C02F 1/44; C02F 3/00

(52) U.S. Cl. CPC C02F 3/1273; C02F 3/006; C02F 1/444; C02F 3/1278; C02F 2209/04; C02F 2209/22; C02F 2303/16; C02F 2101/105

(57) ABSTRACT

A method for removing phosphorus by gasification, the method including: a) providing a membrane bioreactor including a reaction tank and a membrane separation system; b) aerating the reaction tank to control a redox potential in the reaction tank to be higher than −200 mV; and c) controlling the dissolved oxygen concentration around the membrane separation system to be greater than 0 and smaller than 2 mg/L and the dissolved oxygen concentration in the reaction tank excluding the membrane separation system to be greater than 0 and smaller than 1 mg/L, and allowing the dissolved oxygen concentration around the membrane separation system to be higher than the dissolved oxygen concentration in the rest zones of the reaction tank. A phosphorus removal system by gasification includes: a reaction tank, a membrane separation system, a water production system, an aeration system.

### CROSS-REFERENCE TO RELATED APPLICATIONS

This application is a continuation-in-part of International Patent Application No. PCT/CN2015/091067 with an international filing date of Sep. 29, 2015, designating the United States, now pending, and further claims foreign priority benefits to Chinese Patent Application No. 201510552171.X filed Sep. 1, 2015. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to a method and a system for removing phosphorus by gasification.

Description of the Related Art

The conventional biological phosphorus removal employs phosphorus-accumulating organisms (PAOs) to absorb organic compounds and release phosphorus in an anaerobic condition and to take in excess phosphorus from the environment and accumulate the phosphorus in the PAOs to from phosphorus-rich sludge under aerobic conditions. The phosphorus-rich sludge is then discharged from the system. In this way, removal of phosphorus from the wastewater is accomplished. However, the phosphorus removal rate using the method is low and difficult to improve. The excess sludge is generally treated by sanitary landfill, sludge drying, and incineration, which results in secondary pollution and increases carbon emission.

In addition, conventional methods for removing phosphorus using a membrane produce hydrogen sulfide, which is harmful to the environment.

### SUMMARY OF THE INVENTION

In view of the above-described problems, it is one objective of the invention to provide a method and a system for removing phosphorus by gasification without the production of hydrogen sulfide.

To achieve the above objective, in accordance with one embodiment of the invention, there is provided a method for removing phosphorus by gasification, the method comprising:
a) providing a membrane bioreactor comprising a reaction tank and a membrane separation system;
b) aerating the reaction tank to control a redox potential in the reaction tank to be higher than −200 mV; and
c) controlling a dissolved oxygen concentration around the membrane separation system to be greater than 0 and smaller than 2 mg/L and the dissolved oxygen concentration in a reaction tank excluding the membrane separation system to be greater than 0 and smaller than 1 mg/L, and allowing the dissolved oxygen concentration around the membrane separation system to be higher than the dissolved oxygen concentration in rest zones of the reaction tank.

In a class of this embodiment, a concentration ratio of carbon to phosphorus in the reaction tank is controlled to be larger than 25 by adding a carbon source or a phosphorus source.

In a class of this embodiment, the dissolved oxygen concentration around the membrane separation system is greater than 0 and smaller than 1.5 mg/L and the dissolved oxygen concentration in the reaction tank excluding the membrane separation system to be greater than 0 and smaller than 0.8 mg/L.

In another aspect, the invention provides a phosphorus removal system by gasification, the system comprising: a reaction tank, a membrane separation system, a water production system, an aeration system. The membrane separation system is disposed in the reaction tank. The water production system communicates with the membrane separation system for drawing a filtrate from the membrane separation system. The aeration system is adapted to aerate the reaction tank and the membrane separation system. The aeration system is configured to control a redox potential in the reaction tank to be higher than −200 mV, a dissolved oxygen concentration around the membrane separation system to be greater than 0 and smaller than 2 mg/L, and the dissolved oxygen concentration in rest zones of the reaction tank to be greater than 0 and smaller than 1 mg/L. The dissolved oxygen concentration around the membrane separation system is higher than the dissolved oxygen concentration in the rest zones of the reaction tank.

In a class of this embodiment, the dissolved oxygen concentration around the membrane separation system is greater than 0 and smaller than 1.5 mg/L and the dissolved oxygen concentration in the reaction tank excluding the membrane separation system to be greater than 0 and smaller than 0.8 mg/L.

In a class of this embodiment, the membrane separation system adopts a microfiltration membrane or an ultrafiltration membrane.

In a class of this embodiment, the water production system is a suction type water production system or a gravity flow type water production system.

In a class of this embodiment, the system further comprises a scouring system for scouring the membrane separation system. The scouring system adopts an aeration scouring system or a hydraulic scouring system.

In a class of this embodiment, the scouring system adopts the aeration scouring system. The membrane separation system is scoured by concentrating an aeration rate around the membrane separation system.

In a class of this embodiment, the system further comprises a vibration system for vibrating the membrane separation system.

In a class of this embodiment, the system further comprises a washing system. The washing system adopts backwash system or an ultrasonic washing system.

Compared with the prior art, advantages of the phosphorus removal system and method of the present disclosure are summarized as follows: the method and the system for removing phosphorus of the invention are able to remove phosphorus by the production of phosphine (PH₃) and P₂H₄, under the action of the microbes and at the same time no hydrogen sulfide is produced, thereby eliminating the odor.

### BRIEF DESCRIPTION OF THE DRAWINGS

FIG. 1 is a structure diagram of a phosphorus removal system by gasification in accordance with one embodiment of the invention; and

FIG. 2 is a structure diagram of a scouring system of a phosphorus removal system by gasification in accordance with one embodiment of the invention.

### DETAILED DESCRIPTION OF THE EMBODIMENTS

For further illustrating the invention, experiments detailing a method and a system for removing phosphorus by gasification in wastewater treatment are described hereinbelow combined with the drawings.

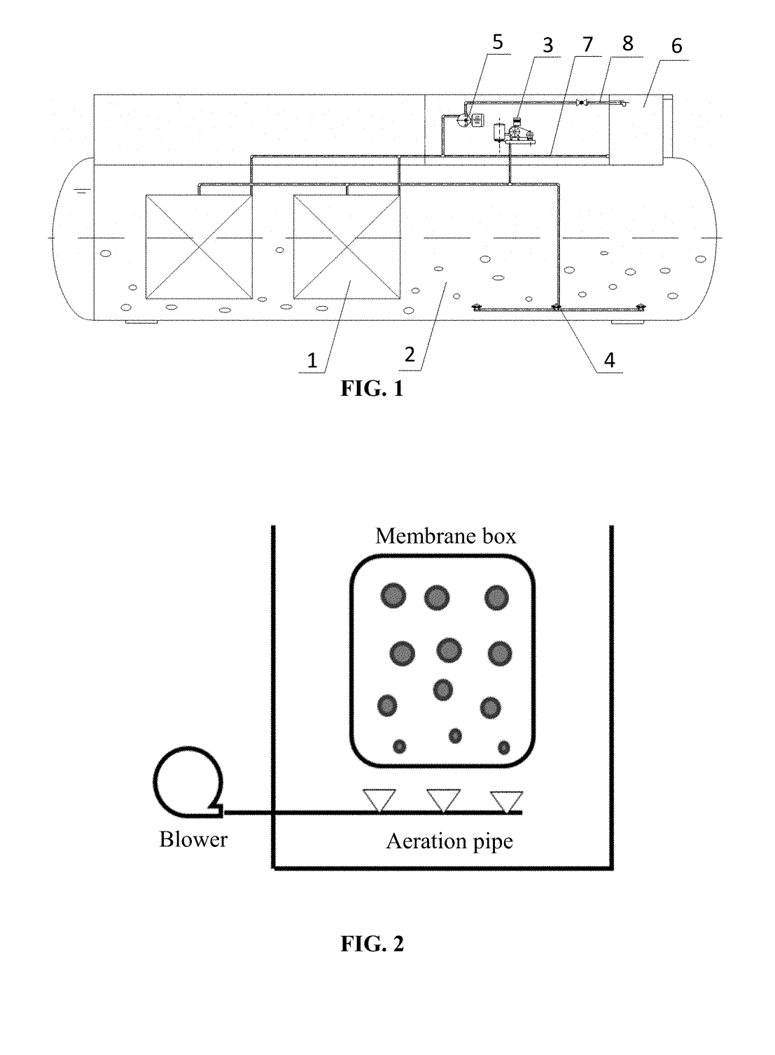

A phosphorus removal system by gasification in wastewater treatment, as shown in FIG. 1, comprises: a membrane separation system 1, a reaction tank 2, a blower 3, an aeration pipe 4, a water extraction pump 5, a clean water pool 6, a backwash pipe 7, and a water production pipe 8. The membrane separation system 1 is an ultrafiltration membrane. The membrane separation system 1 is disposed inside the reaction tank 2. The water extraction pump 5 communicates with the membrane separation system 1 via the water production pipe 8 for drawing a filtrate from the membrane separation system 1 to the clean water pool 6. The reaction tank and the membrane separation system are aerated by the blower 3 via the aeration pipe 4 to produce a dissolved oxygen concentration gradient in the reaction tank as well as scour the membrane separation system 1 by aeration. The backwash pipe 7 is connected to the clean water pool 6 and the membrane separation system 1, so that the membrane separation system 1 is washed by clean water from the clean water pool 6 according to practical demands.

It can be understood that the membrane separation system 1 optionally adopts a microfiltration membrane or other membrane assembly well known in the prior art. The reaction tank 2 optionally adopts a reaction tank in the prior art, such as a reaction pool. An aeration system formed by the blower 3 and the aeration pipe 4 can also use other aeration systems in the prior art. The scouring of the membrane separation system 1 can also be realized by hydraulic scouring. A waster production system formed by the water extraction pump 5 and the water production pipe 8 optionally adopts a gravity flow type water production system or other water production systems in the prior art. The water production pipe 8 and the backwash pipe can be two completely independent pipes or share a common part of pipe. A washing system formed by the backwash pipe 7 and the clean water pool 6 can also adopt an ultrasonic washing system or be replaced by other washing systems.

In addition, the phosphorus removal system by gasification of the invention optionally comprises a vibration system for further preventing the membrane separation system from obstructing by the sludge.

The aeration system is configured to control a redox potential in the reaction tank to be higher than −200 mV. A dissolved oxygen concentration around the membrane separation system is controlled at greater than 0 and smaller than 1.5 mg/L, and the dissolved oxygen concentration in rest zones of the reaction tank is controlled at greater than 0 and smaller than 0.8 mg/L. The dissolved oxygen concentration around the membrane separation system is higher than the dissolved oxygen concentration in the rest zones of the reaction tank. Phosphorus, a constituent for synthesizing cells, is removed under the action of the microbes by gasification and at the same time the production of hydrogen sulfide is prevented, thereby removing the odor.

Taken a municipal domestic sewage as an example, a daily treating capacity of the sewage is 300 tons/day, and a water quality of the sewage to be treated is as follows in Table 1:

TABLE 1

| | | Ammonia | | | |
|---|---|---|---|---|---|
| COD_{Cr} | BOD₅ | nitrogen | TN | TP | Suspended matter |
| (mg/L) | (mg/L) | (mg/L) | (mg/L) | (mg/L) | (mg/L) |
| 350 | 186 | 20 | 40 | 3.5 | 250 |

The sewage is treated by the wastewater treatment system of the invention. The sewage is aerated by the blower 3 for controlling the dissolved oxygen and the redox potential. The dissolved oxygen concentration is maintained at between 0.8 and 1.5 mg/L around the membrane separation system, the dissolved oxygen concentration is maintained at between 0.3 and 0.9 mg/L in the rest zones of the reaction tank, and the redox potential is controlled at approximately −150 mV.

After a duration of cultivation and acclimation under the above control conditions, a microbe community is established. The microbes are intercepted by the membrane separation system and are accumulated in a reaction zone. Phosphorus is absorbed by the microbes from the sewage and becomes a cell constituent, and after the death of the microbes, phosphorus in the cells is removed by gasification under the action of the living microbes in the form of PH₃ and/or P₂H₄. Effluent after treatment is pumped by the water pump out of the reaction system, and the water quality of the effluent is as follows in Table 2:

TABLE 2

| | | | | | Suspended |
|---|---|---|---|---|---|
| COD_{Cr} | BOD₅ | Ammonia | TN | TP | matter |
| (mg/L) | (mg/L) | nitrogen (mg/L) | (mg/L) | (mg/L) | (mg/L) |
| 20 | 2 | 4 | 10 | 0.3 | undetected |

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for removing phosphorus, the method comprising:
a) providing a membrane bioreactor comprising a reaction tank and a membrane separation system;
b) aerating the reaction tank to control a redox potential in the reaction tank to be higher than −200 mV; and
c) controlling a dissolved oxygen concentration around the membrane separation system to be greater than 0 and smaller than 2 mg/L and the dissolved oxygen concentration in the reaction tank excluding the membrane separation system to be greater than 0 and smaller than 1 mg/L, and allowing the dissolved oxygen concentration around the membrane separation system to be higher than the dissolved oxygen concentration in rest zones of the reaction tank.

2. The method of claim 1, wherein a concentration ratio of carbon to phosphorus in the reaction tank is controlled to be larger than 25 by adding a carbon source or a phosphorus source.

3. The method of claim 1, wherein the dissolved oxygen concentration around the membrane separation system is greater than 0 and smaller than 1.5 mg/L and the dissolved oxygen concentration in the reaction tank excluding the membrane separation system to be greater than 0 and smaller than 0.8 mg/L.

4. A phosphorus removal system, comprising:
a reaction tank;
a membrane separation system;
a water production system; and
an aeration system;
wherein
the membrane separation system is disposed in the reaction tank;
the water production system communicates with the membrane separation system for drawing a filtrate from the membrane separation system;
the aeration system is adapted to aerate the reaction tank and the membrane separation system;
the aeration system is configured to control a redox potential in the reaction tank to be higher than −200 mV, a dissolved oxygen concentration around the membrane separation system to be greater than 0 and smaller than 2 mg/L, and the dissolved oxygen concentration in rest zones of the reaction tank to be greater than 0 and smaller than 1 mg/L; and
the dissolved oxygen concentration around the membrane separation system is higher than the dissolved oxygen concentration in the rest zones of the reaction tank.

5. The system of claim 4, wherein the dissolved oxygen concentration around the membrane separation system is greater than 0 and smaller than 1.5 mg/L and the dissolved oxygen concentration in the reaction tank excluding the membrane separation system to be greater than 0 and smaller than 0.8 mg/L.

6. The system of claim 4, wherein the membrane separation system adopts a microfiltration membrane or an ultrafiltration membrane.

7. The system of claim 4, wherein the water production system is a suction type water production system or a gravity flow type water production system.

8. The system of claim 4, further comprising a scouring system for scouring the membrane separation system; wherein the scouring system adopts an aeration scouring system or a hydraulic scouring system.

9. The system of claim 8, wherein the scouring system adopts the aeration scouring system; and the membrane separation system is scoured by concentrating an aeration rate around the membrane separation system.

10. The system of claim 4, further comprising a vibration system for vibrating the membrane separation system.

11. The system of claim 4, further comprising a washing system; wherein the washing system adopts backwash system or an ultrasonic washing system.
